(19) United States
(12) Patent Application Publication
(10) Pub. No.: US 2012/0250972 A1
(43) Pub. Date: Oct. 4, 2012

(54) RADIOGRAPHIC SYSTEM AND RADIOGRAPHIC METHOD

(75) Inventors: Takuji TADA, Kanagawa (JP); Hiroyasu ISHII, Kanagawa (JP); Atsushi HASHIMOTO, Kanagawa (JP)

(73) Assignee: FUJIFILM CORPORATION, Tokyo (JP)

(21) Appl. No.: 13/413,105

(22) Filed: Mar. 6, 2012

(30) Foreign Application Priority Data
Mar. 28, 2011 (JP) 2011-070973

(51) Int. Cl. G06K 9/36

(52) U.S. Cl. 382/132

(57) ABSTRACT

A radiographic system includes an imaging unit, a calculation processing unit. The imaging unit acquires a radiological image including a period pattern modulated by a photographic subject placed at a radiation irradiation field. The calculation processing unit generates a phase contrast image of the photographic subject based on the radiological image acquired by the imaging unit. The calculation processing unit is configured to performing an absorption image generation process, a spatial frequency process, and a phase contrast image generation process.

### CROSS-REFERENCE TO RELATED APPLICATIONS

This application claims the benefit of Japanese Patent Application No. 2011-070973 (filed on Mar. 28, 2011, the entire contents of which are hereby incorporated by reference.

### BACKGROUND

The invention relates to a radiographic system and a radiographic method.

Since X-ray attenuates depending on an atomic number of an element configuring a material and a density and a thickness of the material, it is used as a probe for seeing through an inside of a photographic subject (or object, imaging object). An imaging using the X-ray has been widely spread in fields of medical diagnosis, nondestructive inspection and the like.

In a general X-ray imaging system, a photographic subject is arranged between an X-ray source that irradiates the X-ray and an X-ray image detector that detects an X-ray image and a transmission image of the photographic subject is captured. In this case, the X-ray irradiated from the X-ray source toward the X-ray image detector is subject to the quantity attenuation (absorption) corresponding to differences of the material properties (for example, atomic numbers, densities and thickness) existing on a path to the X-ray image detector and is then incident onto the X-ray image detector. As a result, an X-ray transmission image of the photographic subject is detected and captured by the X-ray image detector. As the X-ray image detector, a flat panel detector (FPD) that uses a semiconductor circuit is widely used in addition to a combination of an X-ray intensifying screen and a film and a stimulable phosphor (accumulative fluorescent material).

However, the smaller the atomic number of the element configuring the material, the X-ray absorption ability is reduced. Accordingly, for the soft biological tissue or soft material, a difference of the X-ray absorption abilities is small and thus it is not possible to acquire the contrast of an image that is enough for the X-ray transmission image. For example, the cartilaginous part and joint fluid configuring an articulation of the body are mostly comprised of water. Thus, since a difference of the X-ray absorption amounts thereof is small, it is difficult to obtain the contrast of an image.

Regarding the above problems, instead of the intensity change of the X-ray by the photographic subject, a research on an X-ray phase imaging of obtaining an image (hereinafter, referred to as a phase contrast image) based on a phase change (angel change) of the X-ray by the photographic subject has been actively carried out in recent years. In general, it has been known that when the X-ray is incident onto an object, the phase of the X-ray, rather than the intensity of the X-ray, shows the higher interaction. Accordingly, in the X-ray phase imaging of using the phase difference, it is possible to obtain a high contrast image even for a weak absorption material having a low X-ray absorption ability. In recent years, regarding the X-ray phase imaging, an X-ray imaging system has been suggested which uses an X-ray Talbot interferometer having two transmission diffraction gratings (phase type grating and absorption type grating) and an X-ray image detector (for example, refer to WO 2004/058070).

The X-ray Talbot interferometer includes a first diffraction grating (phase type grating or absorption type grating) that is arranged at a rear side of a photographic subject, a second diffraction grating (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating forms a self-image by a Talbot interference effect. The self-image is modulated by the interaction (phase change) of the photographic subject, which is arranged between the X-ray source and the first diffraction grating, and the X-ray.

In the X-ray Talbot interferometer, a moiré fringe that is generated by superimposition of the self-image of the first diffraction grating and the second diffraction grating is detected and a change of the moiré fringe by the photographic subject is analyzed, so that phase information of the photographic subject is acquired. As the analysis method of the moiré fringe, a fringe scanning method has been known, for example. According to the fringe scanning method, a plurality of imaging is performed while the second diffraction grating is translation-moved with respect to the first diffraction grating in a direction, which is substantially parallel with a plane of the first diffraction grating and is substantially perpendicular to a grating direction (strip direction) of the first diffraction grating, with a scanning pitch that is obtained by equally partitioning the grating pitch. Then, an angle distribution (differential image of a phase shift) of the X-ray refracted at the photographic subject is acquired from changes of signal values of respective pixels corresponding to the plurality of image data obtained. Based on the acquired angle distribution, it is possible to obtain a phase contrast image of the photogaphic subject.

However, according to the fringe scanning method, it is required to perform the plurality of imaging, so that a quality of the image may be deteriorated due to the moving of the photographic subject during the imaging. Accordingly, a method has been suggested which acquires the phase information of the photographic subject by one imaging by using a Fourier transform and an inverse Fourier transform (for example, refer to WO 2010/050483). According to this method, a frequency domain including a fundamental frequency component of the moiré is separated from a spatial frequency spectrum obtained by Fourier transforming the moiré fringe, the inverse Fourier transform is performed for the separated frequency domain and a differential image of the phase shift is thus acquired. According to the method, it is possible to solve the quality deterioration of the image caused due to the moving of the photographic subject during the imaging and to reduce a radiation exposure amount of the photographic subject.

In the analysis method of the moiré fringe in which the Fourier transform and the inverse Fourier transform are used, it has been known that the frequency domain to be separated is taken as wide as possible and a spatial resolution is thus increased. However, the spatial frequency spectrum that is obtained by Fourier transforming the moiré fringe includes a DC component that is spread on a coordinate axis of a frequency space. The DC component may be caused due to pixel arrangement of the X-ray image detector, non-uniform transmittances of the diffraction gratings and the photographic subject, for example. When the frequency domain to be separated is taken too widely, the DC component is included. Thereby, it may be impossible to acquire the accurate phase shift differential image.

The invention has been made to solve the above problems. An object of the invention is to increase a spatial resolution and a phase restoring accuracy in a radiation phase imaging that acquires phase information of a photographic subject (or object, imaging object) by using the Fourier transform and the inverse Fourier transform.

### SUMMARY OF THE INVENTION

According to an aspect of the invention, a radiographic system includes an imaging unit, a calculation processing unit. The imaging unit acquires a radiological image including a period pattern modulated by a photographic subject (or object, imaging object) placed at a radiation irradiation field. The calculation processing unit generates a phase contrast image of the photographic subject based on the radiological image acquired by the imaging unit. The calculation, processing unit is configured to perform an absorption image generation process, a spatial frequency process, and a phase contrast image generation process. The absorption image generation process is to generate an absorption image in which the period pattern has been removed from the radiological image. The spatial frequency process is to acquire a spatial frequency spectrum in which a DC component of the radiological image has been removed by using a Fourier transform based on the radiological image and the absorption image. The phase contrast image generation process is to separate a frequency domain including a fundamental frequency component of the period pattern from the spatial frequency spectrum in which the DC component has been removed and to generate the phase contrast image by performing an inverse Fourier transform for the separated frequency domain.

According to the invention, the DC component is removed from the frequency spectrum of the radiological image. Therefore, when performing the inverse Fourier transform, it is possible to enlarge the frequency domain to be separated without including an unnecessary frequency component. Thereby, it is possible to increase a spatial resolution and a phase restoring accuracy.

### BRIEF DESCRIPTION OF THE DRAWINGS

FIG. 1 is a pictorial view showing an example of a configuration of a radiographic system for illustrating an illustrative embodiment of the invention.

FIG. 2 is a control block diagram of the radiographic system of FIG. 1.

FIG. 3 is a pictorial view showing a configuration of a radiological image detector of the radiographic system of FIG. 1.

FIG. 4 is a perspective view of an imaging unit of the radiographic system of FIG. 1.

FIG. 5 is a side view of the imaging unit of the radiographic system of FIG. 1.

FIGS. 6A to 6C are pictorial views showing a mechanism for changing a period of a moiré fringe that is formed by first and second gratings of the radiographic system of FIG. 1.

FIG. 7 is a pictorial view for illustrating refraction of radiation by a photographic subject (or object, imaging object).

FIG. 8 is a pictorial view showing an example of the moiré fringe that is formed by the first and second gratings of the radiographic system of FIG. 1.

FIG. 9 is a pictorial view showing a spatial frequency spectrum of the moiré fringe of FIG. 8.

FIG. 10 is a pictorial view for illustrating an example of an absorption image generation process in the radiographic system of FIG. 1.

FIG. 11 is a pictorial view for illustrating another example of an absorption image generation process in the radiographic system of FIG. 1.

FIG. 12 is a flowchart showing an example of a phase contrast image generation process in the radiographic system of FIG. 1.

FIG. 13 is a flowchart showing another example of a phase contrast image generation process in the radiographic system of FIG. 1.

FIG. 14 is a pictorial view showing another example of a phase contrast image generation process in the radiographic system of FIG. 1.

FIG. 15 is a pictorial view showing another example of a phase contrast image generation process in the radiographic system of FIG. 1.

FIG. 16 is a pictorial view showing another example of a configuration of a radiographic system for illustrating an illustrative embodiment of the invention.

FIG. 17 is a pictorial view showing a configuration of a modified embodiment of the radiographic system of FIG. 16.

FIG. 18 is a pictorial view showing another example of a configuration of a radiographic system for illustrating an illustrative embodiment of the invention.

### DETAILED DESCRIPTION

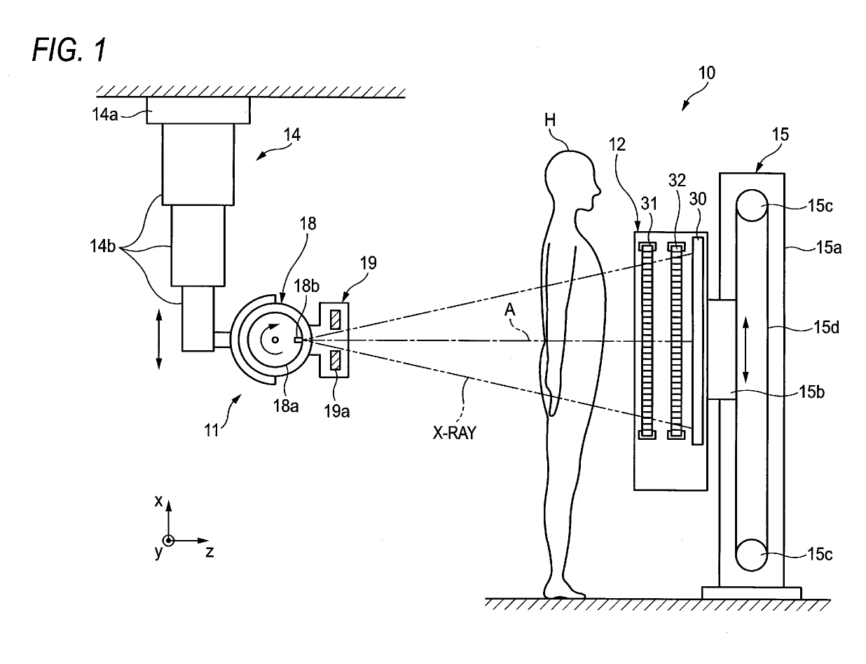

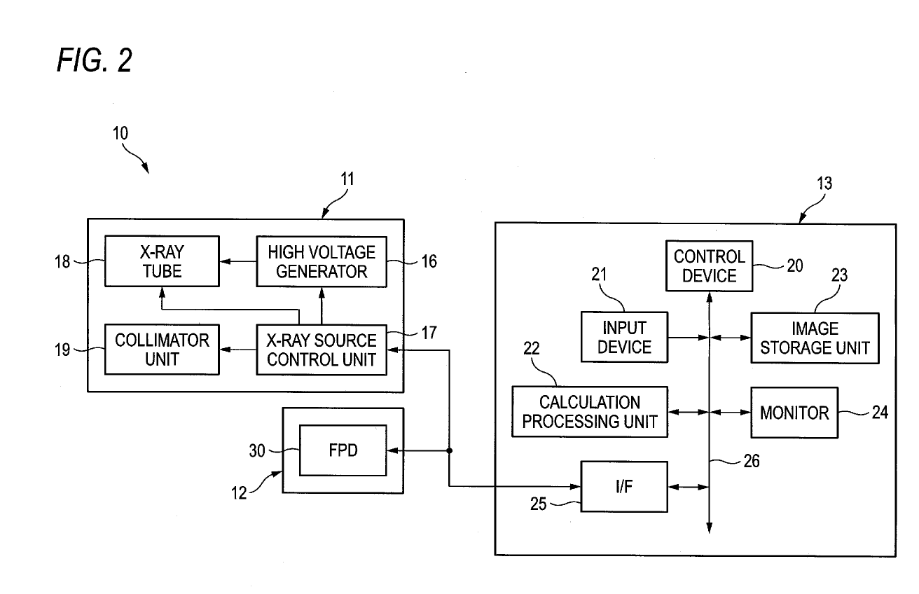

FIG. 1 shows an example of a configuration of a radiographic system for illustrating an illustrative embodiment of the invention and FIG. 2 is a control block diagram of the radiographic system of FIG. 1.

An X-ray imaging system 10 is an X-ray diagnosis apparatus that performs an imaging for a photographic subject (patient) H while the patient stands, and includes an X-ray source 11 that X-radiates the photographic subject (or object, imaging object) H, an imaging unit 12 that is opposed to the X-ray source 11, detects the X-ray having penetrated the photographic subject H from the X-ray source 11 and thus generates image data and a console 13 that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling. The imaging unit 12 is held that it can be moved in the upper-lower direction by an upright stand 15 mounted on the bottom.

The X-ray source 11 includes an X-ray tube 18 that generates the X-ray in response to a high voltage applied from a high voltage generator 16, based on control of an X-ray source control unit 17, and a collimator unit 19 having a moveable collimator 19a that limits an irradiation field so as to shield a part of the X-ray generated from the X-ray tube 18, which part does not contribute to an inspection area of the photographic subject H. The X-ray tube 18 is a rotary anode type that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focus 18b.

The X-ray source holding device 14 includes a carriage unit 14a that is adapted to move in a horizontal direction (z direction) by a ceiling rail (not shown) mounted on the coil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the imaging unit 12 and is attached to the main body 15a so as to move in the upper-lower direction. The holding unit 15b is connected to an endless belt 15d that extends between two pulleys 16c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the imaging unit 12 in the upper-lower direction. The detected value of the position sensor is supplied to the X-ray source holding device 14 through a cable and the like. The X-ray source holding device 14 expands and contracts the struts 14b, based on the detected value, and thus moves the X-ray source 11 to follow the vertical moving of the imaging unit 12.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray irradiation time and the like, an imaging timing and the like are input. The monitor 24 consists of a liquid crystal display and the like and displays letters such as radiography conditions and the X-ray image under control of the control device 20.

The imaging unit 12 has a radiological image detector (FPD: fiat panel detector) 30 that has a semiconductor circuit, and a first absorption type grating 31 and a second absorption type grating 32 that detect a phase change (angle change) of the X-ray by the photographic subject H and perform a phase imaging.

The FPD 30 has a detection surface that is arranged to be orthogonal to the optical axis A of the X-ray irradiated from the X-ray source 11. As specifically described in the below, the first and second absorption type gratings 31, 32 are arranged between the FPD 30 and the X-ray source 11.

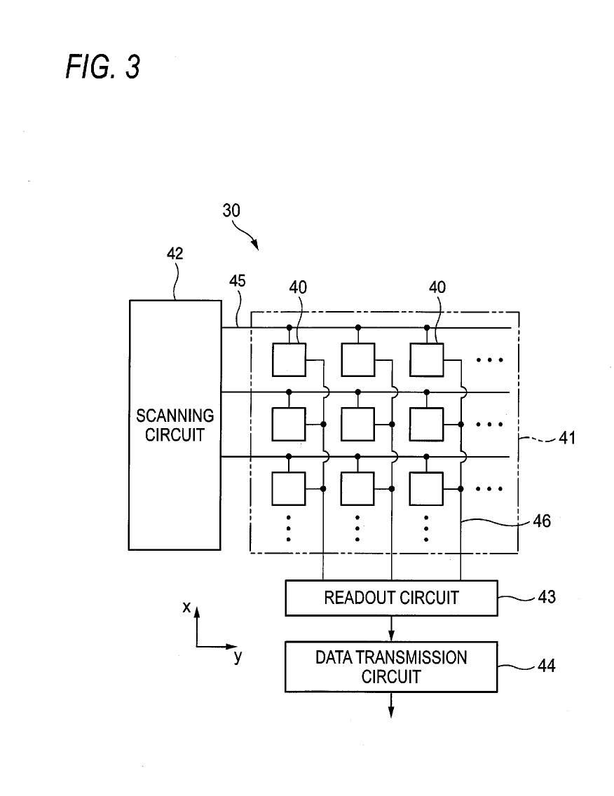

FIG. 3 shows a configuration of the FPD 30.

The FPD 30 includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray into charges with a conversion layer (not shown) made of amorphous selenium and the like and accumulates the converted charges in a capacitor (not shown) connected to a lower electrode. Each pixel 40 is connected with a thin film transistor (TFT) switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

Meanwhile, each pixel 40 may be also configured as an indirect conversion type X-ray detection element that converts the X-ray into visible light with a scintillator (not shown) made of terbium-doped gadolinium oxysulfide (Gd₂O₂S:Tb), thallium-doped cesium iodide (CsI:Tl) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Meanwhile, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

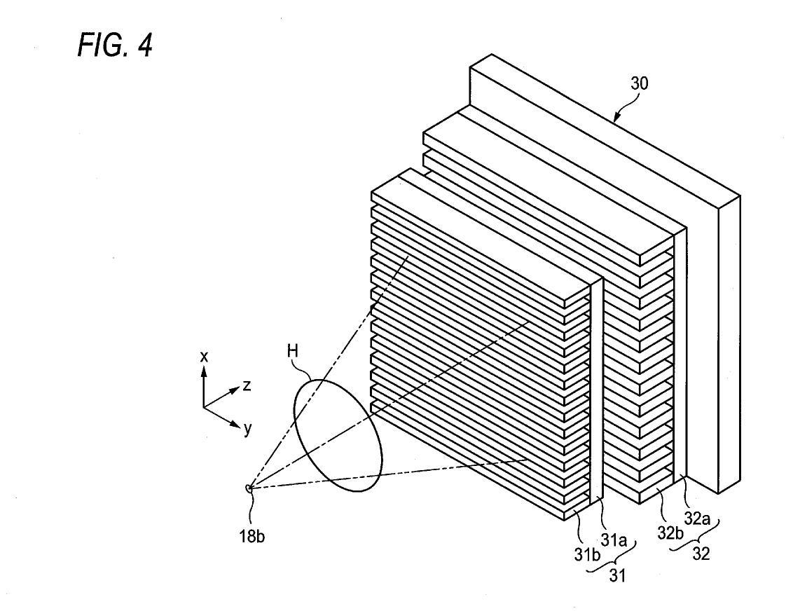

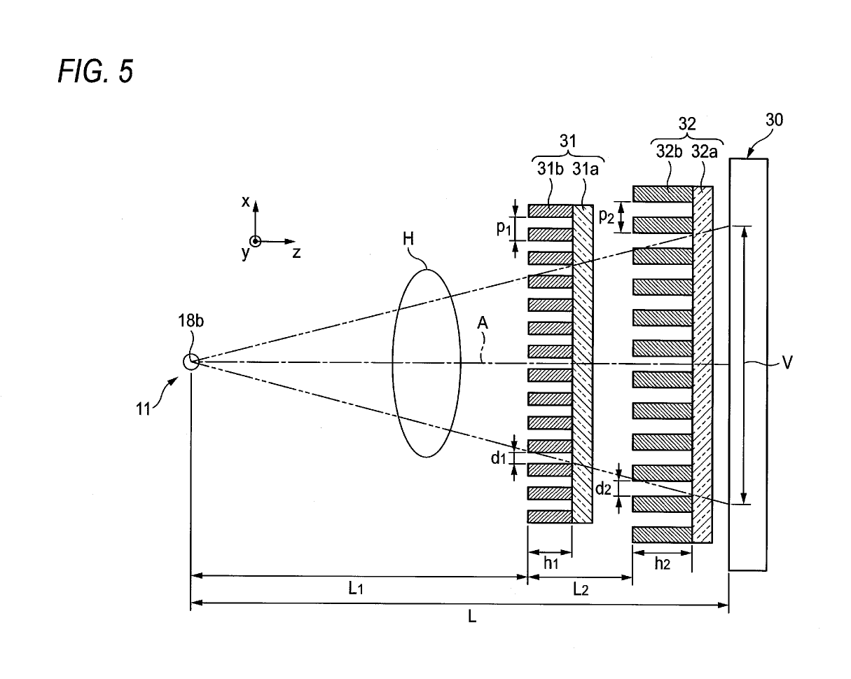

FIGS. 4 and 5 schematically show the configuration of the imaging unit 12.

The first absorption type grating 31 has a X-ray transmission unit (a substrate) 31a and a plurality of X-ray shield units 31b (low radiation absorption units) arranged on the X-ray transmission unit 31a. Likewise, the second absorption type grating 32 has a X-ray transmission unit (a substrate) 32a and a plurality of X-ray shield units 32b (high radiation absorption units) arranged on the X-ray transmission unit 32a. The X-ray transmission units 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having excellent X-ray absorption ability are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant pitch p₁ and at a predetermined interval d₁ in the direction (x direction) orthogonal to the one direction. Likewise, the X-ray shield units 32b are arranged on the in-plane orthogonal to the optical axis A of the X-ray with a constant pitch p₂ and at a predetermined interval d₂ in the direction (x direction) orthogonal to the one direction. Since the first and second absorption type gratings 31, 32 provide the incident X-ray with an intensity difference, rather than the phase difference, they are also referred to as amplitude type gratings. In the meantime, the slit (area of the interval d₁ or d₂) may not be a void. For example, the void may be filled with X-ray low absorption material such as high molecule or light metal.

The first and second absorption type gratings 31, 32 are adapted to geometrically project the X-ray having passed through the slits, regardless of the Talbot interference effect. Specifically; the intervals d₁, d₂ are set to be sufficiently larger than a peak wavelength of the X-ray irradiated from the X-ray source 11, so that most of the X-ray included in the irradiated X-ray is enabled to pass through the, slits while keeping the linearity thereof, without being diffracted in the slits. For example, when the rotary anode 18a is made of tungsten and the tube voltage is 50 kV, the peak wavelength of the X-ray is about 0.4 Å. In this case, when the intervals d₁, d₂ are set to be about 1 to 10 μm, most of the X-ray is geometrically projected in the slits without being diffracted.

Since the X-ray irradiated from the X-ray source 11 is a conical beam having the X-ray focus 18b as an emitting point, rather than a parallel beam, a projection image (hereinafter, referred to as G1 image), which has passed through the first absorption type grating 31 and is projected, is enlarged in proportion to a distance from the X-ray focus 18b. The grating pitch p₂ and the interval d₂ of the second absorption type grating 32 are determined so that the slits substantially coincide with a periodic pattern of bright parts of the G1 image at the position of the second absorption type grating 32. That is, when a distance from the X-ray focus 18b to the first absorption type grating 31 is L₁ and a distance from the first absorption type grating 31 to the second absorption type grating 32 is L₂, the grating pitch p₂ and the interval d₂ are determined to satisfy following equations (1) and (2).

$$\begin{matrix} [ equation 1 ] & \\ {p}_{2} = \text{?} {p}_{1} & ( 1 ) \\ [ equation 2 ] & \\ {d}_{2} = \text{?} {d}_{1} \\ \text{?} \text{indicates text missing or illegible when filed} & ( 2 )\end{matrix}$$

In the Talbot interferometer, the distance L₂ from the first absorption type grating 31 to the second absorption type grating 32 is restrained with a Talbot interference distance that is determined by a grating pitch of a first diffraction grating and an X-ray wavelength. However, in the imaging unit 12 of the X-ray imaging system 10 of this illustrative embodiment, since the first absorption type grating 31 projects the incident X-ray without diffracting the same and the G1 image of the first absorption type grating 31 is similarly obtained at all positions of the rear of the first absorption type grating 31, it is possible to set the distance L₂ irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p₁ of the first absorption type grating 31, the grating pitch p₂ of the second absorption type grating 32, the X-ray wavelength (peak wavelength) and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a conical beam and is known by Atsushi Momose, et al. (Japanese Journal of Applied Physics, Vol. 47, No. 10, 2008, August, page 8077).

In the X-ray imaging system 10, the distance L₂ is set to be shorter than the minimum Talbot interference distance Z when m=1 so as to make the imaging unit 12 smaller. That is, the distance L₂ is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L₂ is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a period pattern image having high contrast, it is preferable that the X-ray shield units 31b, 32b perfectly shield (absorb) the X-ray. However, even when the materials (gold, platinum and the like) having excellent X-ray absorption ability are used, many X-rays penetrate the X-ray shield units without being absorbed. Accordingly, in order to improve the shield ability of X-ray, it is preferable to make thickness h₁, h₂ of the X-ray shield units 31b, 32b thicker as much as possible, respectively. For example, when the tube voltage of the X-ray tube 18 is 50 kV, it is preferable to shield 90% or more of the irradiated X-ray. In this case, the thickness h₁, h₂ are preferably 30 μm or larger, based on gold (Au).

In the meantime, when the thickness h₁, h₂ of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction (strip band direction) of the X-ray shield units 31b, 32b is narrowed. Therefore, from a standpoint of securing the field of view, the upper limits of the thickness h₁, h₂ are defined. In order to secure a length V of the effective field of view in the x direction on the detection surface of the FPD 30, when a distance from the X-ray focus 18b to the detection surface of the FPD 30 is L, the thickness h₁, h₂ are necessarily set to satisfy following equations (7) and (8), from a geometrical relation shown in FIG. 5.

$$\begin{matrix}[ equation 7 ] & \\ {h}_{1} \leq \frac{L}{v / 2} {d}_{1} & ( 7 ) \\ [ equation 8 ] & \\ {h}_{2} \leq \frac{L}{v / 2} {d}_{2} & ( 8 )\end{matrix}$$

For example, when d₁=2.5 μm, d₂=3.0 μm and L=2 m, assuming a typical diagnose in a typical hospital, the thickness h₁ should be 100 μm or smaller and the thickness h₂ should be 120 μm or smaller so as to secure a length of 10 cm as the length. V of the effective field of view in the x direction.

In the imaging unit 12 configured as described above, an intensity-modulated image is formed by the superimposition of the G1 image of the first absorption type grating 31 and the second absorption type grating 32 and is captured by the FPD 30. A pattern period p₁′ of the G1 image at the position of the second absorption type grating 32 and a substantial grating pitch p₂′ (substantial pitch after the manufacturing) of the second absorption type grating 32 are slightly different due to the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p₁′ of the G1 image and the grating pitch p₂′, the image contrast becomes a moiré fringe. A period T of the moiré fringe is expressed by a following equation (9).

$$\begin{matrix}[ equation 9 ] & \\ T = \frac{{p}_{1}^{′} \times {p}_{2}^{′}}{\vert {p}_{1}^{′} \times {p}_{2}^{′} \vert} \frac{L}{{L}_{1} + {L}_{2}} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P of the pixel 40 is not an integer multiple of the moiré period T. Even for a case of n≧2, it is possible to detect the moiré fringe in principle. The equation (11) means that the arrangement pitch P of the pixel 40 is set to be smaller than the moiré period T.

Since the arrangement pitch P of the pixels 40 are design-determined (in, general, about 100 μm) and it is difficult to change the same, when it is intended to adjust a magnitude relation of the arrangement pitch P and the moiré period T, it is preferable to adjust the positions of the first and second absorption type gratings 31, 32 and to change at least one of the pattern period p₁′ of the G1 image and the grating pitch p₂′, thereby changing the moiré period T.

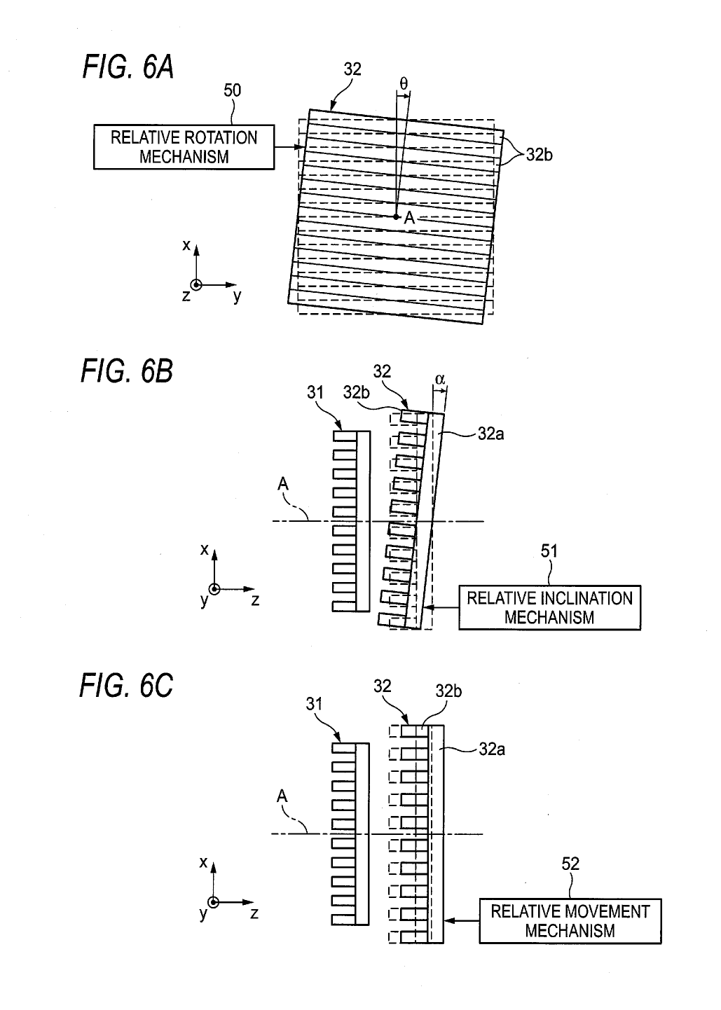

FIGS. 6A, 6B and 6C show methods of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle 0 by the relative rotation mechanism 50, the substantial grating pitch in the x direction is changed from “p₂′” to “p₂′/cos θ”, so that the moiré period T is changed (refer to FIG. 6A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from. “p₂′” to “p₂′×cos α”, so that the moiré period T is changed (refer to FIG. 6B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L₂ between the first absorption type grating 31 and the second absorption type grating 32. When the second absorption type grating 32 is moved along the optical axis A by a moving amount δ by the relative movement mechanism 52, the pattern period of the G1 image of the first absorption type grating 31 projected at the position of the second absorption type grating 32 is changed from “p₁′” to “p₁′×(L₁+L₂+δ)/(L₁+L₂)”, so that the moiré period T is changed (refer to FIG. 6C).

In the X-ray imaging system 10, since the imaging unit 12 is not the Talbot interferometer and can freely set the distance L₂, it can appropriately adopt the mechanism for changing the distance L₂ to thus change the moiré period T, such as the relative movement mechanism 52. The changing mechanisms (the relative rotation mechanism 50, the relative inclination mechanism. 51 and the relative movement mechanism 52) of the first and second absorption type gratings 31, 32 for changing the moiré period T can be configured by actuators such as piezoelectric devices.

When the photographic subject H is arranged between the X-ray source 11 and the first absorption type grating 31, the moiré fringe that is detected by the FPD 30 is modulated by the photographic subject H. An amount of the modulation is proportional to the angle of the X-ray that is deviated by the refraction effect of the photographic subject H. Accordingly, it is possible to generate the phase contrast image of the photographic subject H by analyzing the moiré fringe detected by the FPD 30.

In the below, an analysis method of the moiré fringe is described.

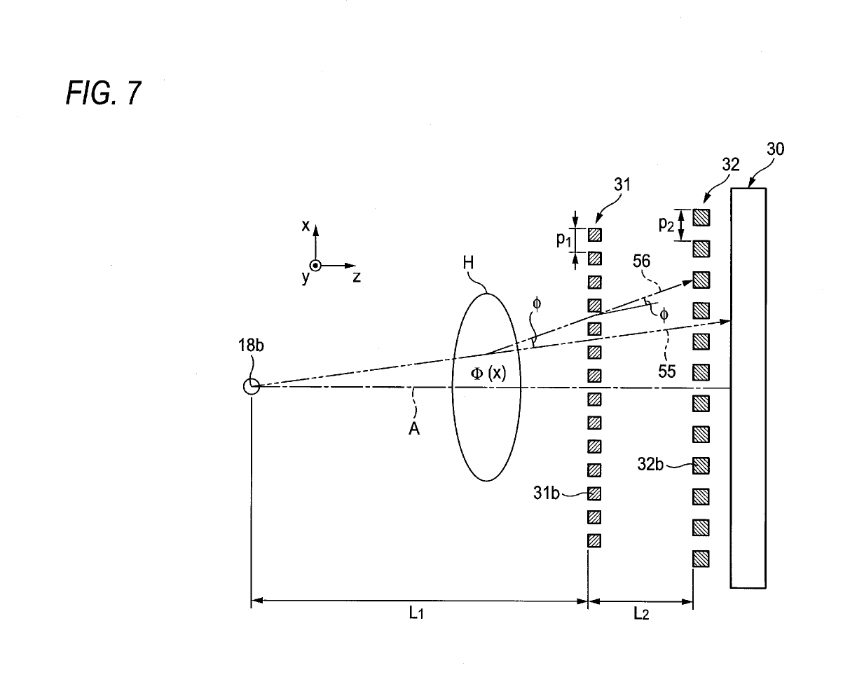

FIG. 7 shows one X-ray that is refracted in correspondence to a phase shift distribution Φ(x) in the x direction of the photographic subject H. In the meantime, a scattering removing grating is not shown.

A reference numeral 55 indicates a path of the X-ray that goes straight when there is no photographic subject H. The X-ray traveling along the path 55 passes through the first and second absorption type gratings 31, 32 and is then incident onto the FPD 30. A reference numeral 56 indicates a path of the X-ray that is refracted and deviated by the photographic subject H. The X-ray traveling along the path 56 passes through the first absorption type grating 31 and is then shielded by the second absorption type grating 32.

The phase shift distribution b(x) of the photographic subject H is expressed by a following equation (12), when a refractive index distribution of the photographic subject H is indicated by n(x, z) and the traveling direction of the X-ray is indicated by z.

$$\begin{matrix}[ equation 12 ] & \\ Φ ( x ) = \frac{2 π}{λ} \int [ 1 - n ( x , z ) ] d z & ( 12 )\end{matrix}$$

Here, the refraction angle φ is expressed by an equation (13) using a wavelength λ of the X-ray and the phase shift distribution Φ(x) of the photographic subject H.

$$\begin{matrix} [ equation 13 ] & \\ ϕ = \frac{λ}{2 π} \text{?} \\ \text{?} \text{indicates text missing or illegible when filed} & ( 13 )\end{matrix}$$

Since the refraction angle φ(x) is a value corresponding to the differential phase value, as shown with the equation (13), the phase shift distribution Φ(x) is obtained by integrating the refraction angle φ(x) along the x axis. In the above descriptions, a y coordinate of the pixel 40 in the y direction is not considered. However, by performing the same calculation for each y coordinate, it is possible to obtain the two-dimensional phase shift distribution Φ(x, y) in the x and y directions.

Here, the moiré fringe that is formed by the first and second absorption type gratings 31, 32 can be expressed by a following equation (14) and the equation (14) can be replaced with a following equation (15).

[equation 14]

I(x, y)=a(x, y)÷b(x, y)cos(2 πf₀x÷φ(x, y)) (14)

[equation 15]

I(x, y)=a(x, y)÷c(x, y)exp(2 πif₀x)+c*(x, y)exp(−2 πif₀x) (15)

In the equation (14), a(x, y) indicates a background, b(x, y) indicates an amplitude of the fundamental frequency component of the moiré fringe and f₀ indicates the fundamental frequency of the moiré fringe. Also, in the equation (15), c(x, y) is expressed by a following equation (16).

[equation 16]

c(x, y)=½b(x, y)exp [iφ(x, y)] (16)

Accordingly, it is possible to obtain the information of the refraction angle φ(x, y) by taking out the components of c(x, y) or c*(x, y) from the moiré fringe. Here, the equation (15) becomes a following equation (17) by the Fourier transform.

[equation 17]

I(fₓ, f_{y})=A(fₓ, f_{y})÷C(fₓ−f₀, f_{y})÷C*(fₓ÷f₀, f_{y}) (17)

In the equation (17), I(fₓ, f_{y}), A(fₓ, f_{y}) and C(fₓ, f_{y}) are two dimensional Fourier transforms of I(x, y), a(x, y) and c(x, y), respectively.

When the one-dimensional gratings such as first and second absorption type gratings 31, 32 are used, the spatial frequency spectrum of the moiré fringe has typically three peaks, i.e., a peak of the DC component deriving from A(fₓ, f_{y}) and peaks of the fundamental frequency components of the moiré deriving from. C(fₓ, f_{y}) and C*(fₓ, f_{y}) with the peak of the DC component being interposed therebetween. The peak deriving from A(fₓ, f_{y}) is generated at the origin and the peaks deriving from C(fₓ, f_{y}) and C*(fₓ, f_{y}) are generated at positions of ±f₀.

When it is intended to obtain the refraction angle φ(x, y) from the spatial frequency spectrum of the moiré fringe, the inverse Fourier transform is performed by cutting out the areas including the peaks of the fundamental frequency components of the moiré fringe and moving the cut out areas so that the peaks overlap with the origin of the frequency space.

Then, it is possible to obtain the refraction angle φ(x, y) from the complex information obtained by the inverse Fourier transform.

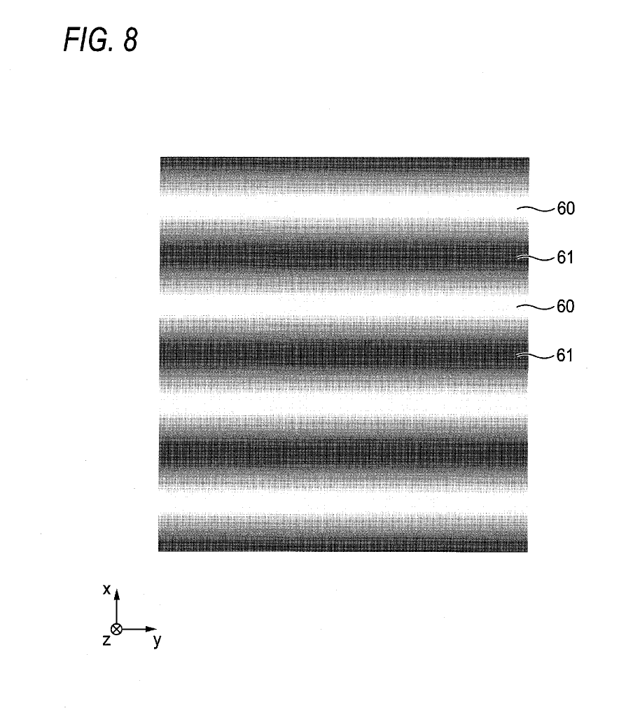

FIG. 8 pictorially shows an example of the moiré fringe.

In FIG. 8, a reference numeral 60 indicates bright parts of the moiré fringe and a reference numeral 61 indicates dark parts of the moiré fringe. The bright parts 60 and the dark parts 61 are alternately arranged side by side in the x direction. Also, the bright parts 60 and the dark parts 61 may be arranged side by side in an oblique direction intersecting with the x direction by relatively rotating one of the first and second absorption type gratings 31, 32 about the optical axis A with the relative rotation mechanism 50 (refer to FIGS. 6A to 6C).

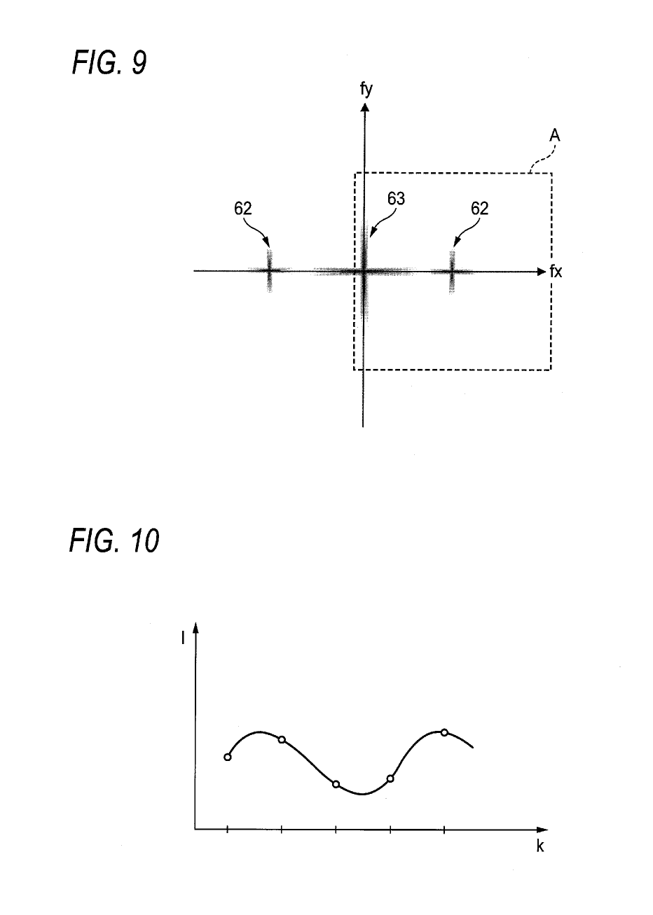

FIG. 9 shows a spatial frequency spectrum that is obtained by performing the fast Fourier transform (FFT), which is a type of the Fourier transform, for the moiré fringe shown in FIG. 8.

As described above, when obtaining the refraction angle φ(x, y) from the spatial frequency spectrum of the moiré fringe by using the inverse Fourier transform, an area centering the peak of a fundamental frequency component 62 (for example, an area surrounded by the dotted line in FIG. 9) is cut out. The larger the cut out area, the higher the spatial resolution when it is converted into an actual space by the inverse Fourier transform. Here, the spatial frequency spectrum of the moiré fringe includes a DC component 63 in addition to the fundamental frequency component 62 of the moiré fringe. When the DC component 63 is included in the cut out area, the restoring accuracy of the phase shift distribution is thus deteriorated. Therefore, an absorption image in which the moiré fringe is removed from a radiological image including the moiré fringe detected by the FPD 30 is generated and then the DC component that is included in the spatial frequency spectrum of the moiré fringe is removed by the absorption image.

First, the method of generating the absorption image is described.

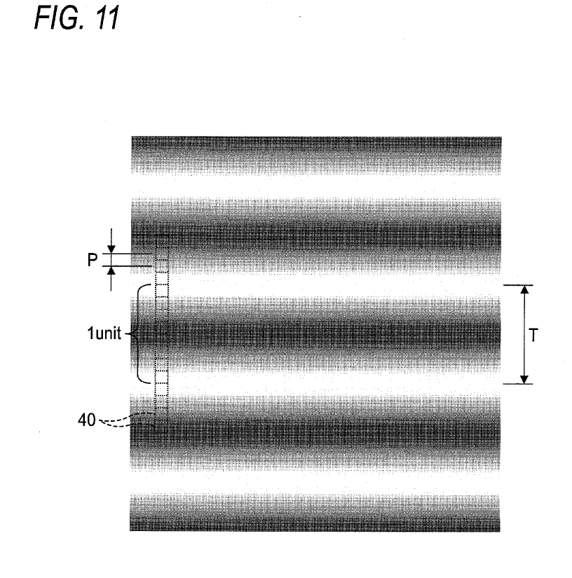

FIG. 10 shows an example of the method of generating the absorption image.

Regarding the arrangement directions (x and y directions) of the pixels 40, three or more pixels 40 adjacent to each other in the direction (x direction in the moiré fringe shown in. FIG. 8) intersecting with the moiré fringe are grouped into one unit. For each unit, pixel values I of the pixels 40 configuring one unit are interpolated with a sinusoidal curve. The interpolation by the sinusoidal curve can be sufficiently made with three points. Accordingly, three or more pixels 40 adjacent to each other are grouped into one unit. Then, a smoothing process is performed in which an average value of the sinusoidal curves is assumed as the pixel values of the pixels 40. Thereby, it is possible to generate the absorption image in which the moiré has been removed.

FIG. 11 shows another example of the method of generating the absorption image.

First, regarding the arrangement directions of the pixels 40, a moiré period T of the moiré fringe in the direction (x direction in the moiré fringe shown in FIG. 8) intersecting with the moiré fringe is obtained. The moiré period T can be directly estimated from a radiological image including the moiré fringes detected by the FPD 30, or alternatively, may be calculated from the spatial frequency spectrum that is obtained by performing the Fourier transform process for the radiological image.

When the moiré period T is an integer multiple of the arrangement pitch P of the pixels 40 in the x direction, the pixels 40 of n periods (n: natural number) of the moiré fringe, which are adjacent to each other in the x direction, are grouped into one unit. Then, for each unit, the smoothing process is performed in which an average value of the pixel values of the pixels 40 configuring one unit is assumed as the pixel values of the pixels 40. Thereby, it is possible to generate the absorption image in which the moiré has been removed. According to this method, since the interpolation by the sinusoidal curve is not necessary, it is possible to easily generate the absorption image. Also, from a standpoint of the spatial resolution, it is preferable to perform the smoothing process with the pixels 40 of one period of the moiré fringe being grouped into one unit.

Also, the method of generating the absorption image in which the moiré fringe has been removed is not limited to the above. In addition, regarding the arrangement directions of the pixels 40, for the direction (x direction in the moiré fringe shown in FIG. 8) intersecting with the moiré fringe, it may be possible to perform the smoothing process by using the pixel values of the adjacent pixels, for each pixel. For example, regarding the arrangement of the pixels 40 in the x direction, when the k^{th} pixel 40 is smoothed with m pixels, a pixel value of the k^{th} pixel 40 is expressed with Iₖ and the smoothing process is performed by using the m pixel values of Iₖ, Iₖ₊₁, . . . , Iₖ₊ₘ₋₁. Also, it is possible to generate the absorption image in which the moiré fringes have been removed by a frequency process of suppressing the frequency components above the fundamental frequency of the moiré fringe or near the fundamental frequency.

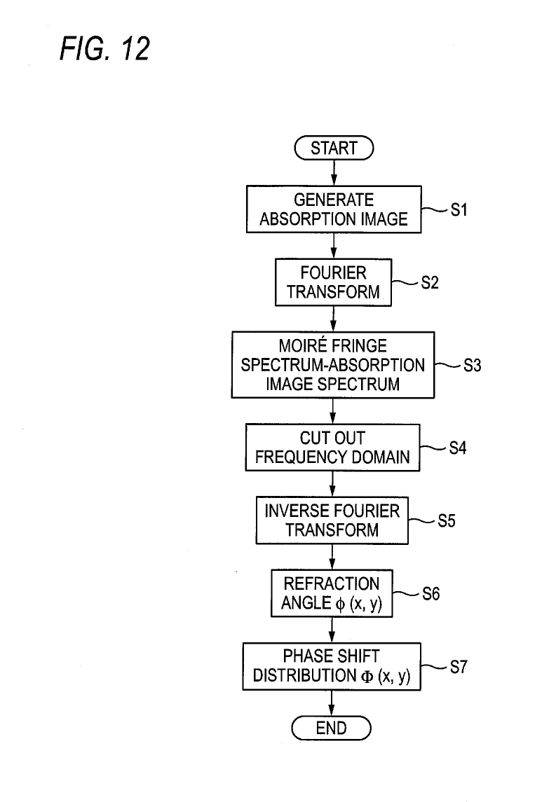

FIG. 12 is a flowchart showing an example of a process of generating a phase contrast image.

First, an absorption image is generated from a radiological image including the moiré fringe detected by the FPD 30 (step S1).

Then, the Fourier transform process is performed for the radiological image and the absorption image, so that respective spatial frequency spectrums are acquired (step S2). The spatial frequency spectrum of the radiological image includes the fundamental frequency component and the DC component of the moiré fringe. In the meantime, the spatial frequency spectrum of the absorption image in which the moiré fringe has been removed includes only the DC component.

Then, the spatial frequency spectrum of the absorption image is subtracted from the spatial frequency spectrum of the radiological image (step S3). Thereby, it is possible to acquire the spatial frequency spectrum of the moiré fringe in which the DC component has been removed. The DC component is also caused due to the photographic subject H. The absorption image includes the photographic subject H and it is possible to remove the DC component more accurately, compared to a case where the spatial frequency spectrum of the background image having no photographic subject H is subtracted.

Then, from the spatial frequency spectrum in which the DC component has been removed, a predetermined area centering the peak of the fundamental frequency component of the moiré fringe is cut out (step S4). Since the DC component has been removed, it is possible to set the cut out area (for example, the area surrounded by the dotted line A of FIG. 9) including the origin of the frequency space in which the peak of the DC component has been located.

Then, the inverse Fourier transform is performed by moving the cut out area so that the peak of the fundamental frequency component of the moiré fringe overlaps with the origin of the frequency space (step S5). Then, the refraction angle φ(x, y) is obtained from the complex information obtained by the inverse Fourier transform (step S6).

Then, the differential amounts of the phase shift distribution acquired from the refraction angle φ(x, y) are integrated along the x axis and the same calculation is performed for each of the y coordinates, so that two-dimensional phase shift distribution Φ(x, y) in the x and y directions is obtained (step S7).

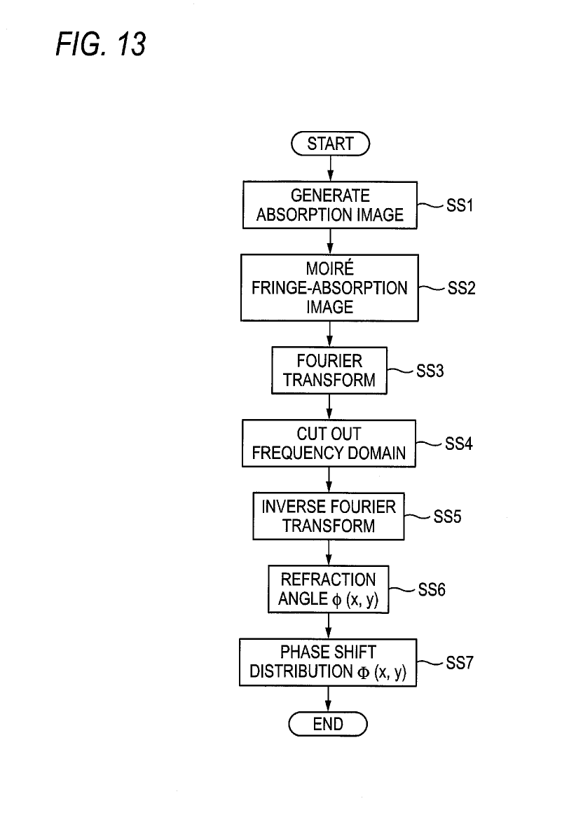

FIG. 13 is a flowchart showing another example of a process of generating a phase contrast image.

First, an absorption image is generated from a radiological image including the moiré fringe detected by the FPD 30 (step SS1).

Then, the absorption image is subtracted from the radiological image (step SS2).

Then, the Fourier transform process is performed for the radiological image in which the absorption image has been subtracted, so that the spatial frequency spectrum thereof is acquired (step SS3). Since the absorption image has been already subtracted, the spatial frequency spectrum does not include the DC component.

Then, from the spatial frequency spectrum of the moiré fringe in which the DC component has been removed, a predetermined area centering the peak of the fundamental frequency component of the moiré fringe is cut out (step SS4). Since the DC component has been removed, it is possible to set the cut out area (for example, the area surrounded by the dotted line A of FIG. 9) including the origin of the frequency space in which the peak of the DC component has been located.

Then, the inverse Fourier transform is performed by moving the cut out area so that the peak of the fundamental frequency component of the moiré overlaps with the origin of the frequency space (step SS5). Then, the refraction angle φ(x, y) is obtained from the complex information obtained by the inverse Fourier transform (step SS6).

Then, the differential amounts of the phase shift distribution acquired from the refraction angle φ(x, y) are integrated along the x axis and the same calculation is performed for each of the y coordinates, so that two-dimensional phase shift distribution Φ(x, y) in the x and y directions is obtained (step SS7).

Like this, when the Fourier transform is performed for the radiological image in which the absorption image has been already subtracted and thus the spatial frequency spectrum is obtained, it is possible to reduce the calculation load, compared to the configuration in which the Fourier transform process is performed for the radiological image and the absorption image and the spatial frequency spectrums thereof are respectively obtained and the spatial frequency spectrum of the absorption image is subtracted from the spatial frequency spectrum of the radiological image.

Also, it may be possible that the radiological image is divided by the absorption image and then normalized, instead of subtracting the absorption image from the radiological image. Also in this configuration, it is possible to obtain the spatial frequency spectrum in which the DC component has been removed.

The above process is performed by the calculation processing unit 22. The calculation processing unit 22 stores the phase contrast image, which is obtained by imaging the phase shift distribution Φ(x, y), in the storage unit 23. After the operator inputs the imaging instruction through the input device 21, the respective units operate in cooperation with each other under control of the control device 20, so that the generation process of the phase contrast image is automatically performed and the phase contrast image of the photographic subject H is finally displayed on the monitor 24.

As described above, the DC component has been removed from the frequency spectrum of the radiological image and it is possible to enlarge the frequency domain to be separated without including the unnecessary frequency components when performing the inverse Fourier transform. Thereby, it is possible to increase the spatial resolution and the phase restoring accuracy.

Also, according to the X-ray imaging system 10, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L₂ from the first absorption type grating 31 to the second absorption type grating 32 and to set the distance L₂ to be smaller than the minimum Talbot interference distance of the Talbot interferometer, it is possible to miniaturize the imaging unit 12. Further, in the X-ray imaging system of this illustrative embodiment, since the substantially entire wavelength components of the irradiated X-ray contribute to the projection image (G1 image) from the first absorption type grating 31 and the contrast of the moiré fringe is thus improved, it is possible to improve the detection sensitivity of the phase contrast image.

Also, according to the X-ray imaging system 10, the second grating is superimposed on the projection image of the first grating, so that the moiré fringe is generated. Accordingly, it has been described that both the first and second gratings are the absorption type gratings. However, the invention is not limited thereto. As described above, the invention is useful even when the second grating is superimposed on the Talbot interference image and the moiré fringe is thus generated. Accordingly, the first grating is not limited to the absorption type grating and may be a phase type grating.

Also, it has been described that the image based on the phase shift distribution Φ is stored and displayed as the phase contrast image. However, the phase shift distribution Φ is obtained by integrating the differential amounts of the phase shift distribution Φ calculated from the refraction angle φ, and the refraction angle φ and the differential amounts of the phase shift distribution Φ are also related to the phase change of the X-ray by the photographic subject. Accordingly, the image based on the refraction angle φ and the image based on the differential amounts of the phase shift are also included in the phase contrast image.

Also, it may be possible to perform the phase contrast image generation process and to acquire the phase contrast image for the moiré fringe that is acquired by performing the imaging (pre-imaging) at a state in Which there is no photographic subject (or object, imaging object). This phase contrast image reflects the phase non-uniformity (deviation of the initial phase) caused due to the non-uniformity of the first and second absorption type gratings 31, 32, for example. By subtracting the phase contrast image, which is acquired through the pre-imaging, from the phase contrast image that is acquired by performing the imaging (main imaging) at a state in which there is a photographic subject (or object, imaging object), it is possible to acquire the phase contrast image in which the phase non-uniformity of the imaging unit 12 has been corrected.

In addition, the arrangement pitch P of the pixels 40 of the FPD 30 is typically larger than the pattern period p₁′ of the G1 image (the grating pitch p₁ of the first absorption type grating 31) and the FPD 30 cannot resolve the period pattern of the G1 image. Therefore, the moiré fringe is generated by using the second absorption type grating 32 and the modulation of the moiré fringe by the photographic subject H is analyzed to generate the phase contrast image. However, when an FPD or other X-ray image detector capable of resolving the G1 image (i.e., the arrangement pitch of the pixels thereof is sufficiently smaller than the pattern period of the G1 image) is used, it is possible to directly analyze the period pattern of the G1 image by the photographic subject H and to thus generate the phase contrast image. In this case, the second absorption type grating 32 may be omitted.

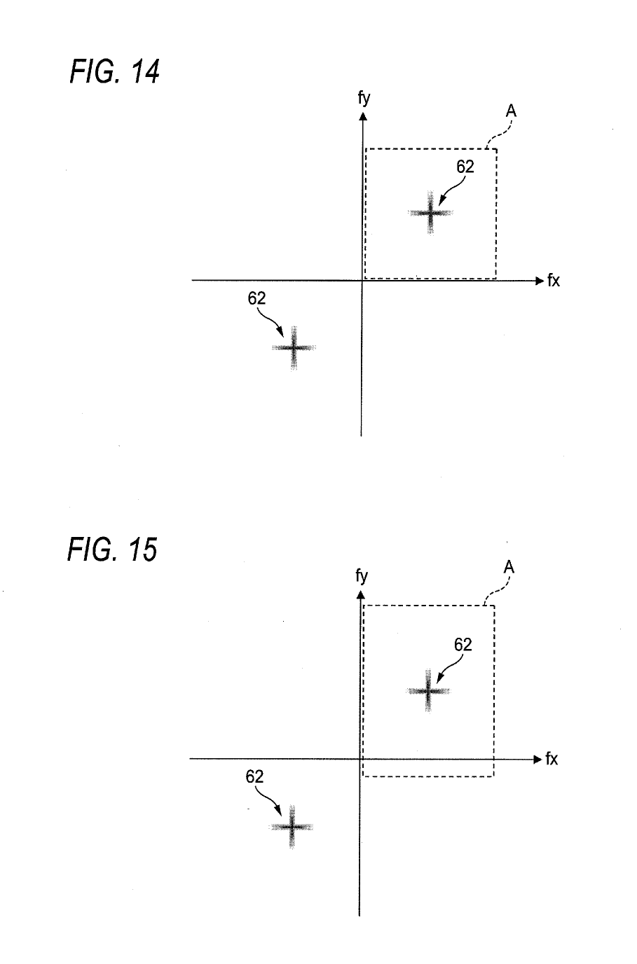

Also, it has been described that, in the phase contrast image generation process, the frequency domain including the origin of the frequency space is cut out when performing the inverse Fourier transform. However, as shown in FIG. 14, it may be possible to cut out a frequency domain A having a boundary adjacent to at least one coordinate axis of the frequency space. Alternatively, as shown in FIG. 15, it may be possible to cut out a frequency domain A extending over at least one coordinate axis. Also in any case, the DC component is removed from the spatial frequency spectrum, so that the frequency domain A to be cut out does not include an unnecessary frequency component. Thus, compared to the configuration in which the frequency domain is cut out while avoiding the DC component, it is possible to enlarge the frequency domain to be cut out. Thereby, it is possible to improve the spatial resolution and the phase restoring accuracy.

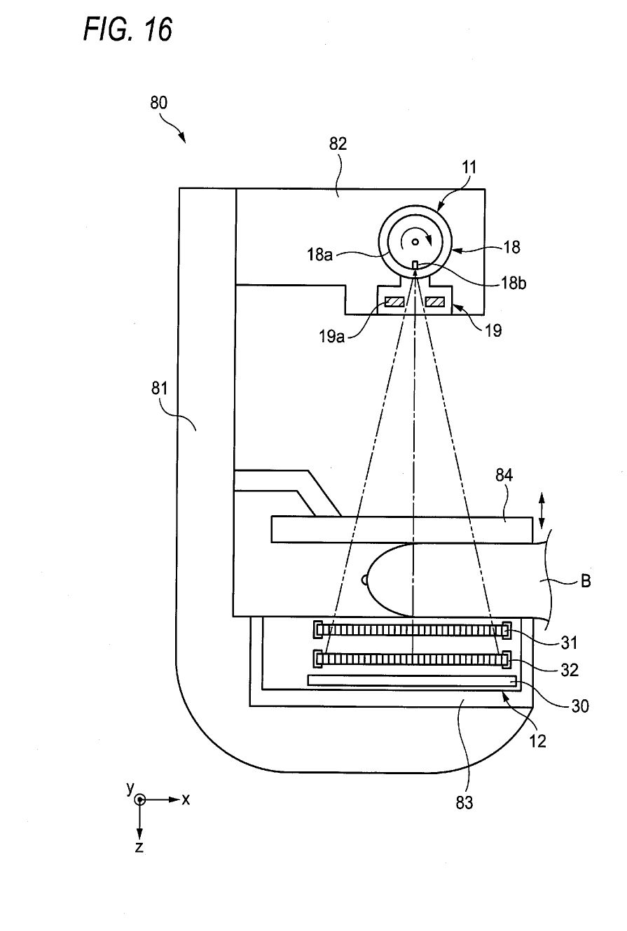

FIG. 16 shows another example of the radiographic system for illustrating an illustrative embodiment of the invention.

A mammography apparatus 80 shown in FIG. 16 is an apparatus of capturing an X-ray image (phase contrast image) of a breast B that is the photographic subject (or object, imaging object). The mammography apparatus 80 includes an X-ray source accommodation unit 82 that is mounted to one end of an arm member 81 rotatably connected to a base platform (not shown), an imaging platform 83 that is mounted to the other end of the arm member 81 and a pressing plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The pressing plate 84 is moved by a moving mechanism (not shown) and presses the breast B between the pressing plate and the imaging platform 83. At this pressing state, the X-ray imaging is performed.

The configurations of the X-ray source 11 and the imaging unit 12 are the same as those of the X-ray imaging system 10. Therefore, the respective constitutional elements are indicated with the same reference numerals as the X-ray imaging system 10. Since the other configurations and the operations are the same as the above, the descriptions thereof are also omitted.

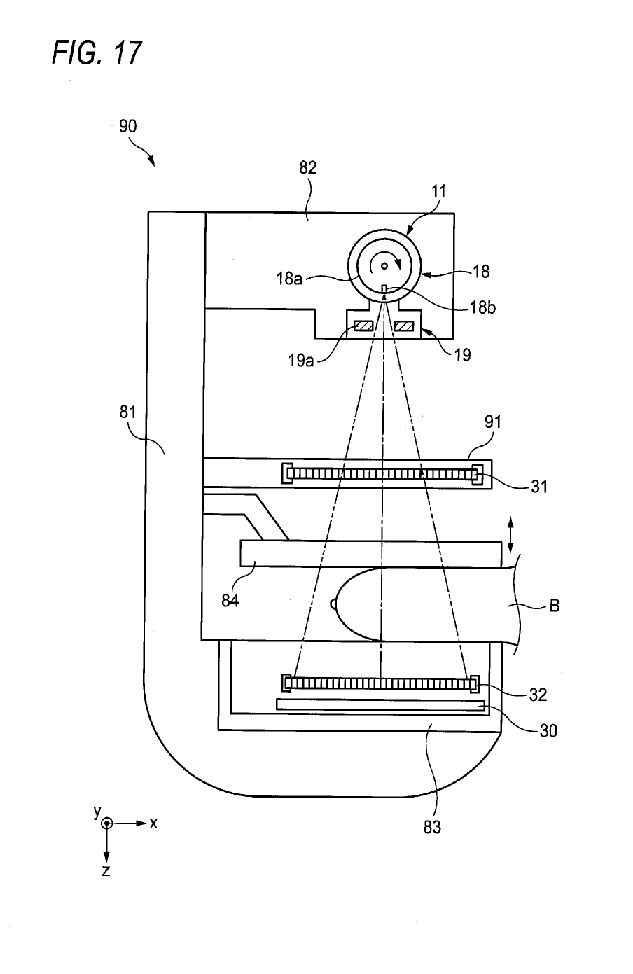

FIG. 17 shows a modified embodiment of the radiographic system of FIG. 16.

A mammography apparatus 90 shown in FIG. 17 is different from the mammography apparatus 80 in that the first absorption type grating 31 is provided between the X-ray source 11 and the pressing plate 84.

Like this, even when the object to be diagnosed (breast) B is positioned between the first absorption type grating 31 and the second absorption type grating 32, the projection image (G1 image) of the first absorption type grating 31, which is formed at the position of the second absorption type grating 32, is deformed by the object to be diagnosed B. Accordingly, also in this case, it is possible to detect the moiré fringe, which is modulated due to the object to be diagnosed B, by the FPD 30. That is, also with the mammography apparatus 90, it is possible to obtain the phase contrast image of the object to be diagnosed B by the above-described principle.

In the mammography apparatus 90, since the X-ray whose radiation dose has been substantially halved by the shielding of the first absorption type grating 31 is irradiated to the object to be diagnosed B, it is possible to decrease the radiation exposure amount of the object to be diagnosed B about by half, compared to the above mammography apparatus 80. In the meantime, like the mammography apparatus 90, the configuration in which the object to he diagnosed is arranged between the first absorption type grating 31 and the second absorption type grating 32 can be applied to the above X-ray imaging system 10.

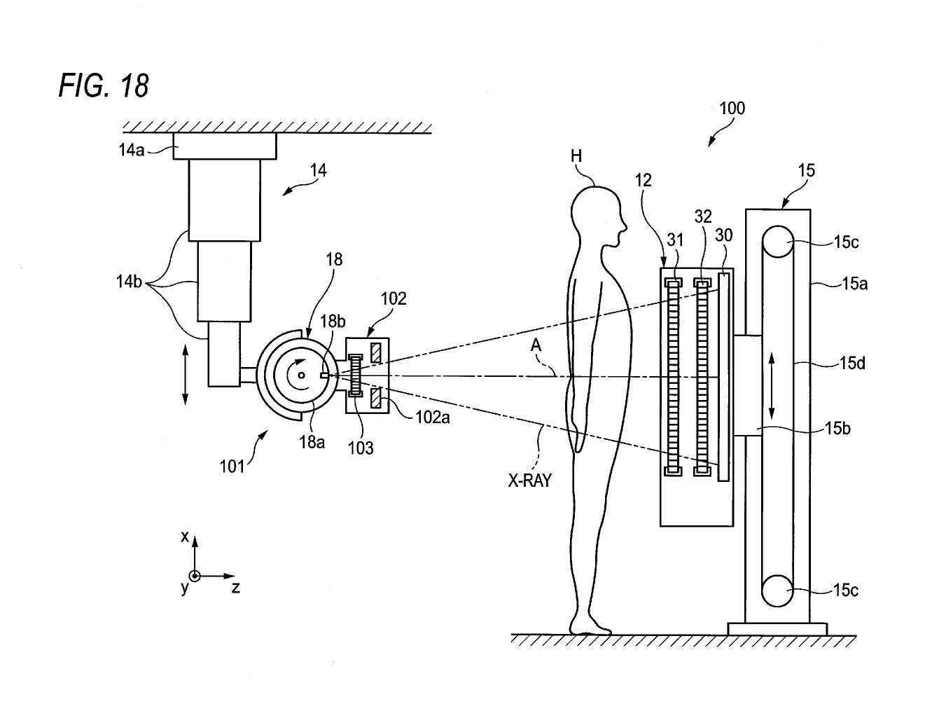

FIG. 18 shows another example of the radiographic system for illustrating an illustrative embodiment of the invention.

A radiographic system 100 is different from the radiographic system 10 in the first embodiment in that a multi-slit 103 is provided to a collimator unit 102 of an X-ray source 101. Since the other configurations are the same as the above X-ray imaging system 10, the descriptions thereof are omitted.

In the above X-ray imaging system 10, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focus 18b, so that the quality of the phase contrast image may be deteriorated. Accordingly, it may be considered that a pin hole is provided just after the X-ray focus 18b to effectively reduce the focus size. However, when an opening area of the pin hole is decreased so as to reduce the effective focus size, the X-ray intensity is lowered. In the X-ray imaging system 100 of this illustrative embodiment, in order to solve this problem, the multi-slit 103 is arranged just after the X-ray focus 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation emitted from the X-ray source 11, thereby reducing the effective focus size in the x direction and forming a plurality of point light sources (disperse light sources) in the x direction.

It is necessary to set a grating pitch p₃ of the multi-slit 103 so that it satisfies a following equation (19), when a distance from the multi-slit 103 to the first absorption type grating 31 is L₃.

$$\begin{matrix} [ equation 18 ] & \\ {p}_{3} = \text{?} \\ \text{?} \text{indicates text missing or illegible when filed} & ( 18 )\end{matrix}$$

The equation (18) is a geometrical condition so that the projection images (G1 images) of the X-rays, which are emitted from the respective point light sources dispersedly formed by the multi-slit 103, by the first absorption type grating 31 coincide (overlap) at the position of the second absorption type grating 32.

Also, since the position of the multi-slit 103 is substantially the X-ray focus position, the grating pitch p₂ and the interval d₂ of the second absorption type grating 32 are determined to satisfy following equations (19) and (20).

$$\begin{matrix} [ equation 19 ] & \\ {p}_{2} = \text{?} {p}_{1} & ( 19 ) \\ [ equation 20 ] & \\ {d}_{2} = \text{?} {d}_{1} \\ \text{?} \text{indicates text missing or illegible when filed} & ( 20 )\end{matrix}$$

Like this, in the X-ray imaging system 100 of this illustrative embodiment, the G1 images based on the point light sources formed by the multi-slit 103 overlap, so that it is possible to improve the quality of the phase contrast image without lowering the X-ray intensity. The above multi-slit 103 can be applied to any of the X-ray imaging systems.

In the respective X-ray imaging systems, it has been described that the general X-ray is used as the radiation. However, the radiation that is used for the invention is not limited to the X-ray. For example, the radiations except for the X-ray, such as a-ray and γ-ray, may be also used.

Like this, the specification discloses the radiographic system of (1) to (15), the radiographic method of (16) and the program of (17), as follows.

(1) A radiographic system including: an imaging unit that acquires a radiological image including a period pattern modulated by a photographic subject (or object, imaging object) arranged in a radiation irradiation field, and a calculation processing unit that generates a phase contrast image of the photographic subject, based on the radiological image acquired by the imaging unit, wherein the calculation processing unit performs an absorption image generation process of generating an absorption image in which the period pattern has been removed from the radiological image, a spatial frequency process of using a Fourier transform to acquire a spatial frequency spectrum in which a DC component of the radiological image has been removed, based on the radiological image and the absorption image, and a phase contrast image generation process of separating a frequency domain including a fundamental frequency component of the period pattern from the spatial frequency spectrum in which the DC component has been removed and performing an inverse Fourier transform for the separated frequency domain to generate a phase contrast image.

(2) In the radiographic system according to the above (1), the calculation processing unit, in the spatial frequency process, subtracts or divides the absorption image from the radiological image and performs the Fourier transform for the radiological image in which the absorption image has been subtracted or divided, thereby acquiring the spatial frequency spectrum in which the DC component has been removed.

(3) In the radiographic system according to the above (1), the calculation processing unit, in the spatial frequency process, performs the Fourier transform for the radiological image and the absorption image, respectively, to acquire spatial frequency spectrums thereof and subtracts the spatial frequency spectrum of the absorption image from the spatial frequency spectrum of the radiological image, thereby acquiring the spatial frequency spectrum in which the DC component has been removed.

(4) In the radiographic system according to one of the above (1) to (3), the imaging unit includes a detector having an image receiving unit in which pixels detecting radiation are arranged in two directions, and the calculation processing unit, in the absorption image generation process, smoothes pixel values of the respective pixels in an intersecting direction, of the arrangement directions of the pixels, intersecting with the period pattern, thereby generating the absorption image.

(5) In the radiographic system according to the above (4), the calculation processing unit, in the absorption image generation process, groups a plurality of pixels adjacent to each other in the intersecting direction into one unit and performs the smoothing process for each pixel configuring the unit by using the pixels.

(6) In the radiographic system according to the above (4), the calculation processing unit, in the absorption image generation process, performs the smoothing process for each pixel by using the corresponding pixel and at least one pixel adjacent to the corresponding pixel in the intersecting direction.

(7) In the radiographic system according to the above (5) or (6), the calculation processing unit uses three or more pixels in the smoothing process.

(8) In the radiographic system according to the above (7), the calculation processing unit, in the smoothing process, interpolates pixel values of the pixels to be used for the smoothing process by a predetermined interpolation curve and thus calculates an average value of the interpolation curve and assumes the calculated average value to be the pixel values of the pixels to be smoothed in the smoothing process.

(9) In the radiographic system according to the above (5) or (6), a period of the period pattern is an integer multiple of a period of the pixels in the direction of the arrangement directions of the pixels intersecting with the period pattern, and the calculation processing unit, in the smoothing process, uses the pixels included in an area of n periods (n: natural number) of the period pattern.

(10) In the radiographic system according to the above (9), the calculation processing unit, in the smoothing process, calculates an average value of the pixels to be used for the smoothing process and assumes the calculated average value to be the pixel values of the pixels to be smoothed in the smoothing process.

(11) In the radiographic system according to one of the above (1) to (10), the calculation processing unit, in the phase contrast image generation process, separates the frequency domain, which includes the fundamental frequency component of the period pattern and an origin of a frequency space, from the spatial frequency spectrum in which the DC component has been removed.

(12) In the radiographic system according to one of the above (1) to (10), the calculation processing unit, in the phase contrast image generation process, separates the frequency domain, which includes the fundamental frequency component of the period pattern and extends over at least one coordinate axis of a frequency space, from the spatial frequency spectrum in which the DC component has been removed.

(13) In the radiographic system according to one of the above (1) to (10), the calculation processing unit, in the phase contrast image generation process, separates the frequency domain, which includes the fundamental frequency component of the period pattern and has a boundary adjacent to at least one coordinate axis of a frequency space, from the spatial frequency spectrum in which the DC component has been removed.

(14) In the radiographic system according to one of the above (1) to (13), the imaging unit includes a first grating and a second grating having high radiation absorption units and low radiation absorption units alternately arranged thereto and the period pattern is a moiré fringe that is formed as the second grating is superimposed on the radiological image formed by radiation having passed through the first grating.

(15) In the radiographic system according to one of the above (1) to (13), the imaging unit includes a first grating having high radiation absorption units and low radiation absorption units alternately arranged thereto and the period pattern is a period pattern of the radiological image that is formed by radiation having passed through the first grating.

(16) A radiographic method of generating a phase contrast image of a photographic subject (or object, imaging object) based on a radiological image including a period pattern modulated by the photographic subject arranged in a radiation irradiation field, the method including: generating an absorption image in which the period pattern has been removed from the radiological image, using a Fourier transform to acquire a spatial frequency spectrum in which a DC component of the radiological image has been removed, based on the radiological image and the absorption image, separating a frequency domain including a fundamental frequency component of the period pattern from the spatial frequency spectrum in which a DC component of the radiological image has been removed, and performing an inverse Fourier transform for the separated frequency domain to generate a phase contrast image.

(17) A program enabling a computer to execute:

an image generation process of generating, from a radiological image including a period pattern modulated by a photographic subject (or object, imaging object) arranged in a radiation irradiation field, an absorption image in which the period pattern has been removed;

a spatial frequency process of using a Fourier transform to acquire a spatial frequency spectrum in which a DC component of the radiological image has been removed, based on the radiological image and the absorption image, and
a phase contrast image generation process of separating a frequency domain including a fundamental frequency component of the period pattern from the spatial frequency spectrum in which a DC component of the radiological image has been removed and performing an inverse Fourier transform for the separated frequency domain to generate a phase contrast image.

What is claimed is:

1. A radiographic system comprising:
an imaging unit that acquires a radiological image including a period pattern modulated by a photographic subject placed at a radiation irradiation field, and
a calculation processing unit that generates a phase contrast image of the photographic subject based on the radiological image acquired by the imaging unit,
wherein the calculation processing unit is configured to perform:
an absorption image generation process to generate an absorption image in which the period pattern has been removed from the radiological image,
a spatial frequency process to acquire a spatial frequency spectrum in which a DC component of the radiological image has been removed by using a Fourier transform based on the radiological image and the absorption image, and
a phase contrast image generation process to separate a frequency domain including a fundamental frequency component of the period pattern from the spatial frequency spectrum in which the DC component has been removed and to generate the phase contrast image by performing an inverse Fourier transform for the separated frequency domain.

2. The radiographic system according to claim 1, wherein the calculation processing unit, in the spatial frequency process, acquires the spatial frequency spectrum in which the DC component has been removed by subtracting or dividing the absorption image from the radiological image and performing the Fourier transform for the radiological image in which the absorption image has been subtracted or divided.

3. The radiographic system according to claim 1, wherein the calculation processing unit, in the spatial frequency process, acquires the spatial frequency spectrum in which the DC component has been removed by performing the Fourier transform for the radiological image and the absorption image, respectively, to acquire spatial frequency spectrums thereof and subtracting the spatial frequency spectrum of the absorption image from the spatial frequency spectrum of the radiological image.

4. The radiographic system according to claim. 1, wherein the imaging unit includes a detector having an image receiving unit in which pixels for detecting radiation are arranged in two directions, and
wherein the calculation processing unit, in the absorption image generation process, smoothes pixel values of the respective pixels in an intersecting direction, of the arrangement directions of the pixels, intersecting with the period pattern, thereby generating the absorption image.

5. The radiographic system according to claim 4, wherein the calculation processing unit, in the absorption image generation process, groups a plurality of pixels adjacent to each other in the intersecting direction into one unit and performs the smoothing process for each pixel configuring the unit by using the pixels.

6. The radiographic system according to claim 4, wherein the calculation processing unit, in the absorption image generation process, performs the smoothing process for each pixel by using the corresponding pixel and at least one pixel adjacent to the corresponding pixel in the intersecting direction.

7. The radiographic system according to claim 5, wherein the calculation processing unit uses three or more pixels in the smoothing process.

8. The radiographic system according to claim 7, wherein the calculation processing unit, in the smoothing process, interpolates pixel values of the pixels to be used for the smoothing process by a predetermined interpolation curve and thus calculates an average value of the interpolation curve and assumes the calculated average value to be the pixel values of the pixels to be smoothed in the smoothing process.

9. The radiographic system according to claim 5, wherein a period of the period pattern is an integer multiple of a period of the pixels in the direction of the arrangement directions of the pixels intersecting with the period pattern, and
wherein the calculation processing unit, in the smoothing process, uses the pixels included in an area of n periods (n: natural number) of the period pattern.

10. The radiographic system according to claim 9, wherein the calculation processing unit, in the smoothing process, calculates an average value of the pixels to be used for the smoothing process and assumes the calculated average value to be the pixel values of the pixels to be smoothed in the smoothing process.

11. The radiographic system according to claim 1, wherein the calculation processing unit, in the phase contrast image generation process, separates the frequency domain, which includes the fundamental frequency component of the period pattern and an origin of a frequency space, from the spatial frequency spectrum in which the DC component has been removed.

12. The radiographic system according to claim 1, wherein the calculation processing unit, in the phase contrast image generation process, separates the frequency domain, which includes the fundamental frequency component of the period pattern and extends over at least one coordinate axis of a frequency space, from the spatial frequency spectrum in which the DC component has been removed.

13. The radiographic system according to claim 1, wherein the calculation processing unit, in the phase contrast image generation process, separates the frequency domain, which includes the fundamental frequency component of the period pattern and has a boundary adjacent to at least one coordinate axis of a frequency space, from the spatial frequency spectrum in which the DC component has been removed.

14. The radiographic system according to claim 1, wherein the imaging unit comprises a first grating and a second grating, the first grating having high radiation absorption units and low radiation absorption units alternately arranged thereto, and
the period pattern is a moiré fringe that is formed as the second grating is superimposed on the radiological image formed by radiation having passed through the first grating.

15. The radiographic system according to claim 1, wherein the imaging unit comprises a first grating having high radiation absorption units and low radiation absorption units alternately arranged thereto, and
the period pattern is a period pattern of the radiological image that is formed by radiation having passed through the first grating.

16. A radiographic method for generating a phase contrast image of a photographic subject based on a radiological image including a period pattern modulated by the photographic subject arranged in a radiation irradiation field, the method comprising:
generating an absorption image in which the period pattern has been removed from the radiological image,
acquiring a spatial frequency spectrum in which a DC component of the radiological image has been removed by using a Fourier transform based on the radiological image and the absorption image,
separating a frequency domain including a fundamental frequency component of the period pattern from the spatial frequency spectrum in which a DC component of the radiological image has been removed, and
generating a phase contrast image by performing an inverse Fourier transform for the separated frequency domain.

17. A computer readable medium storing a program causing a computer to execute a process for a radio graphic, the process comprising:
an image generation process for generating, from a radiological image including a period pattern modulated by a photographic subject arranged in a radiation irradiation field, an absorption image in which the period pattern has been removed;
a spatial frequency process for acquiring a spatial frequency spectrum in which a DC component of the radiological image has been removed, based on the radiological image and the absorption image by using a Fourier transform, and
a phase contrast image generation process for separating a frequency domain including a fundamental frequency component of the period pattern from the spatial frequency spectrum in which a DC component of the radiological image has been removed and generating a phase contrast image by performing an inverse Fourier transform for the separated frequency domain.

18. The radiographic system according to claim 1, wherein the imaging unit comprises a first grating and a second grating, the first grating being a phase type grating, and
the period pattern is a moiré fringe that is formed as the second grating is superimposed on the radiological image formed by radiation having passed through the first grating.

19. The radiographic system according to claim 1, wherein the imaging unit comprises a first grating being a phase type grating, and
the period pattern is a period pattern of the radiological image that is formed by radiation having passed through the first grating.
